(19) United States
(12) Patent Application Publication
(10) Pub. No.: US 2005/0108585 A1
(43) Pub. Date: May 19, 2005

(54) Silent loading of executable code

(76) Inventor: Chiang Han Yang, Sunnyvale, CA (US)

Correspondence Address: PHOENIX TECHNOLOGIES LTD., 915 MURPHY RANCH ROAD, MILPITAS, CA, 95035, US

(21) Appl. No.: 10/877,485

(22) Filed: Jun. 25, 2004

Related U.S. Application Data
(60) Provisional application No. 60/523,452, filed on Nov. 19, 2003.

(51) Int. Cl. G06F 1/26

(52) U.S. Cl. 713/310

(57) ABSTRACT

An electronic device includes at least one processor and a first memory coupled to the at least one processor. The memory contains instructions that when executed by the processor, causes the at least one processor to receive a power down event command. When the power down event command is received, an alternate executable program is loaded into a second memory and the electronic device is placed in a stand by mode. A device operation method includes receiving a power down event command while executing a first executable program. Upon receiving the power down event command, loading an alternate executable program, and enter a standby mode. When a power on command is received, resume operation from the standby mode under the control of the alternate executable program.

The present application claims the benefit of U.S. Provisional Application No. 60/523,452, filed Nov. 19, 2003.

### FIELD OF THE INVENTION

The present invention generally relates to core systems software and, more particularly, to loading a secondary executable program during the inactive period of an electronic device.

### BACKGROUND OF THE INVENTION

Electronic devices, for example, laptop computers, desktop computers, personal digital assistants (PDA's), Internet appliances; embedded devices, for example, routers and set top boxes, wireless communication devices, for example, cellular telephones and similar devices typically include a controller, for example, a central processing unit and memory which contains core system software code that is operable to initialize and configure the underlying subsystems, for example, display controller, I/O controller and other suitable subsystems of the electronic device. After the subsystems have been initialized and configured, electronic device control is transferred to a suitable operating system. After device control transfer, the operating system may call and execute any number of application programs, for example, word processing programs, MP3 players, image generation and manipulation programs, browsers and other suitable programs and combinations thereof.

When an electronic device is first powered on for example, by a user turning on or resetting the device, or the receipt of a resume or other activation or initialization command, the operating system is initially loaded. Loading the operating system can take on the order of up to two minutes. In order for the electronic device to be useful, application programs must be loaded into memory by the operating system. Application program loading increases the delay the user experiences between powering on and actually using the electronic device. The total delay may be up to four minutes; which is unacceptable to most users.

### SUMMARY OF THE INVENTION

A device operation method includes receiving a power down event command while executing a first executable program. Upon receipt of the power down event command, the device loads an alternate executable program into fast access (e.g. RAM) memory and enters a standby mode. The loading of the alternate executable program is performed by the core system software of the device. The user is not aware of the alternate executable program loading as it is performed during the corresponding power down or applicable power management cycle. When device operation is subsequently resumed, for example, upon receipt of a power on command, device operation is immediately resumed under control of the alternate executable program. As the alternate executable program was loaded into the fast access memory before the device entered standby mode, the latency between receipt of the power on command and complete usability of the device is significantly reduced as compared to standard devices which require loading from a slower non-volatile memory.

An electronic device includes at least one processor and a first memory that is coupled to the at least one processor. The first memory contains instructions that when executed by the at least one processor, causes the at least one processor to receive a power down event command. When the power down event command is received, a second or alternate executable program is loaded into a second memory and the electronic device is placed in a stand by mode. When a resume or other suitable command is received by the at least one processor, device execution is resumed under the control of the second or alternate executable program.

### BRIEF DESCRIPTION OF THE DRAWINGS

The present invention and the advantages and features provided thereby will be best appreciated and understood upon review of the following detailed description of the invention, taken in conjunction with the following drawings, where like numerals represent like elements, in which:

FIG. 1 is a schematic block diagram of an electronic device incorporating the silent load functionality of the present invention;

FIG. 2 is a flow chart illustrating the operating steps performed by the electronic device when performing the silent load functionality according to the present invention; and

FIG. 3 is a timing diagram illustrating electronic device operation according to the present invention.

### DETAILED DESCRIPTION OF THE INVENTION

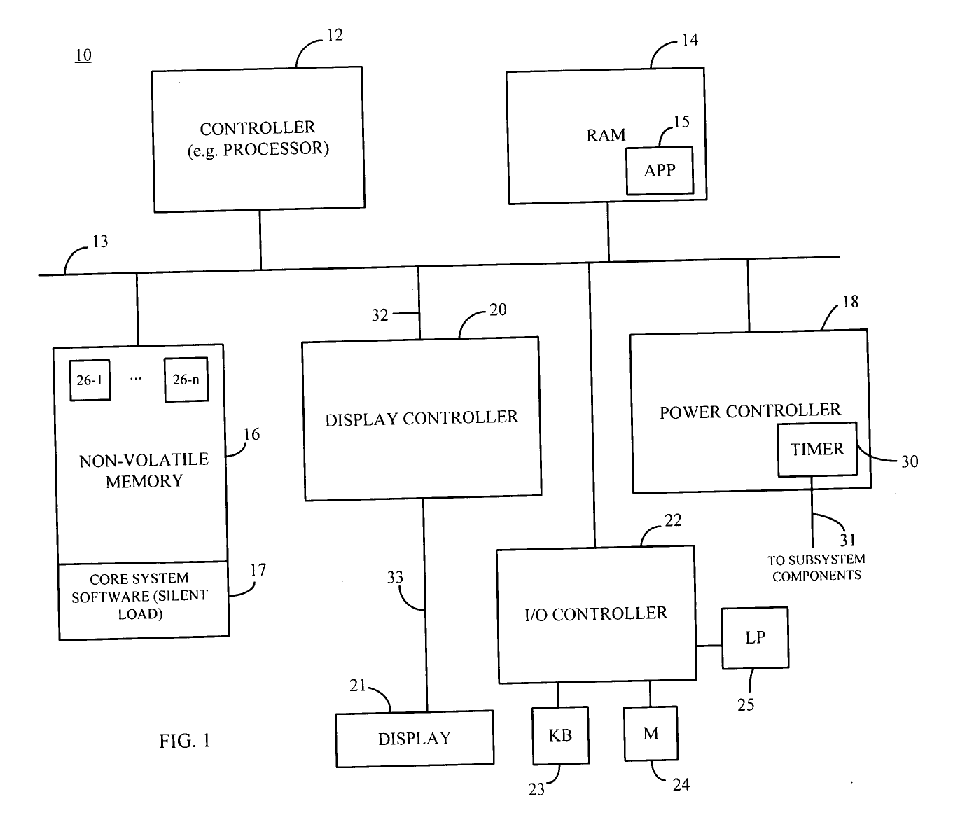

FIG. 1 is a schematic block diagram of an exemplary electronic device 10, for example, a desktop computer, laptop computer, tablet PC, personal digital assistant (PDA), Internet appliance; embedded device, for example, a router or set top box, a wireless communication device, for example, a cellular telephone or other suitable device or combination thereof implementing the silent load functionality of the present invention. For purposes of illustration and not limitation, the electronic device 10 is represented as a laptop computer including at least one processor or other suitable controller 12, a fast access (e.g. RAM) or second memory 14 coupled to the processor 12 via bus 13, a non-volatile (e.g. ROM, NVRAM, flash) or first memory 16, a power controller 18, a display controller 20 and an input/output (I/O) controller 22.

The processor 12 may include an arithmetic logic unit (ALU) for performing computations, one or more registers for temporary storage of data and instructions, and a controller for controlling the operations of the laptop computer 10. In one embodiment, the processor 12 includes any one of the X86, Pentium™ and Pentium Pro™ microprocessors manufactured by Intel Corporation, or the K-6 microprocessor marketed by Advanced Micro Devices. Further examples include the 6X86MX microprocessor as marketed by Cyrix Corp., the 680X0 processor marketed by Motorola; or the Power PC™ processor marketed by International Business Machines. In addition, any of a variety of other processors, including those from Sun Microsystems, MIPS, NEC, Cyrix and others may be used for implementing the processor 12. The processor 12 is not limited to microprocessors, but may take on other forms such as microcontrollers, digital signal processors (DSP), dedicated hardware (e.g. ASIC), state machines or software executing on one or more processors distributed over a network.

The bus 13 may be implemented, for example, as one or more wires that contain and provide for the transfer of address and/or data information, a carrier wave including one or more modulated signals containing address and/or data information or any suitable medium for transferring signals or combination thereof. If the device 10 includes wireless capability, the bus 13 would transmit and receive signals through a transceiver, for example, an antenna or other suitable device (not shown). Alternatively, the bus 13 may be implemented as a bus controller that is coupled to a system bus implemented, for example, by a peripheral component interface (PCI) bus, an industry standard architecture (ISA) bus, a universal serial bus (USB) bus or other suitable communication medium.

The RAM 14 is a fast access memory that maintains application programs 15, for example, word processing, accounting, e-mail, MP3 players, browsers and other suitable programs or combinations thereof that are transferred to the processor 12 for execution via bus 13. RAM 14 contents are maintained when the laptop computer 10 is in either the full power or stand by mode, but are not maintained during the power off or power down state. Although the RAM 14 is described as being a volatile memory, those of ordinary skill in the art will recognize and appreciate that other memory configurations, for example, memory distributed over a network may be used in place of the RAM 14 and such alternate configurations are contemplated by and fall within the spirit of the present invention and the scope of the present disclosure.

The non-volatile memory 16 may be implemented for example, by a read only memory (ROM), flash memory, a plurality of memory devices, distributed memory such as servers coupled to a network or other suitable device capable of maintaining electrical signals therein. The non-volatile memory 16 includes a portion thereof dedicated to the core system software (CSS) code 17, which is used among other things to initialize and configure the hardware and other subsystems, for example, display controller 20, I/O controller 22 of the laptop computer 10 during an initial power on or resume operation. The CSS 17 includes instructions or code segments that when executed by the processor 12, cause the processor 12 to implement the silent load functionality according to the present invention. The instructions or code segments can be stored in a processor readable medium or transmitted by a computer data signal embodied in a carrier wave over a transmission medium or communication link. Examples of the processor readable medium include, but are not limited to, an electronic circuit, a semiconductor memory device, a read only memory (ROM), a flash memory, an erasable ROM (EROM), a floppy diskette, a CD-ROM, an optical disk, a hard disk, a fiber optic medium, a radio frequency (RF) link, and the like or any combination thereof. The computer data signal may include any signal that can propagate over a transmission medium such as electronic network channels, optical fibers, air, electromagnetic, RF links and the like. The code segments may be downloaded via computer networks, such as the Internet, intranet, LAN, WAN and the like.

A series of executable programs 26-1 to 26-n are also maintained in the non-volatile memory 16. These executable programs 26-1 to 26-n may include, among other things, a first operating system (e.g. Windows™) code, a second operating system (e.g. Linux) code or application program code. The contents of the non-volatile memory 16 are maintained during power off or non-operating cycles of the laptop computer 10. In application, when the laptop computer 10 is initially powered up, for example, by a user depressing a power button or an application program initiating a resume operation, the CSS code 17 causes the processor to initiate and configure the underlying subsystems, for example, display controller 20, I/O controller 22 of the laptop computer 10, load the primary or first operating system, and then transfer control of the laptop computer 10 to the primary operating system. After receiving control of the laptop computer 10, the primary operating system loads and executes any number of a variety of application programs 15.

The power controller 18 may include a power supply that controls the power level of the laptop computer 10 and may also include a timer 30 for measuring any applicable time-out periods. For example, if no activity is received or performed by or on the laptop computer 10 in a predetermined period, portions of the laptop computer 10 for example, the display controller 20 may be placed in a low power mode by a time-out command or signal 31 according to techniques known to those or ordinary skill in the art. The power controller 18 also controls the hibernate mode (via time-out signal 31) of the laptop computer 10, where the contents of the RAM 14 are transferred to the non-volatile memory 16 before the laptop computer 10 is placed into hibernate state or minimal power mode for example by powering down the processor 12.

The display controller 20 receives image data 32 from the processor 12 and provides formatted data 33 for display on a suitable display 21, for example, a CRT, flat panel or other suitable device capable of presenting images and/or data. The formatted data 33 may also be maintained in the RAM 14 for subsequent display or manipulation.

The input/output (I/O) controller 22 is operative to control the transfer of information between the processor 12 and a plurality of user input devices, for example, keyboard (KB) 23, mouse (M) 24, light pointer (LP) 25 or other suitable input and corresponding output devices, for example, a printer (not shown). Interconnecting the user input devices 23-25 to the I/O controller is known to those of ordinary skill in the art and will not be discussed in greater detail here so as not obscure the discussion of the present invention.

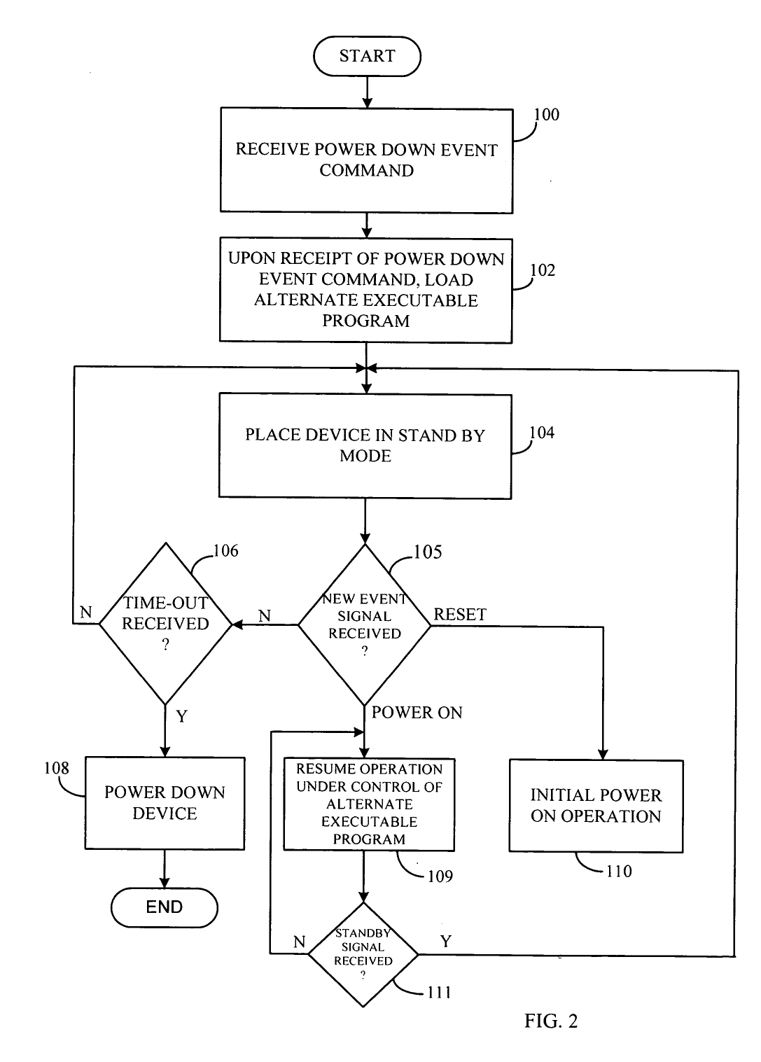

FIG. 2 is a flow chart illustrating the operations performed by the processor 12 when performing the silent load functionality according to the present invention. The initial portion of the flow chart corresponds to the laptop computer being in a power on or executing mode. In step 100, a power down event command, for example, a shut down or hibernate command is received by the processor 12. This occurs, for example, when the user turns the laptop computer 10 off or when the power controller 18 signals that power should be removed from at least one portion of the laptop computer 10.

In step 102, upon receipt of the power down event command, a second or alternate executable program is loaded into the fast access memory. This is accomplished, for example, by the processor 12 reading a second operating system, for example, Linux from the non-volatile memory 16 and writing the second or alternate operating system image into the fast access or second memory 14. Alternatively, the processor 12 may read an application program from the non-volatile memory 16 and write the image of the application program into the fast access or second memory 14. Thus, during the power down cycle when the first, or primary, operating system is being terminated, the second or alternate executable program (e.g. Linux operating system) is written or otherwise loaded into RAM or fast access memory 14 without the knowledge of or any action required of the user. Thus, the aforementioned operations are referred to as being silent.

In step 104, the laptop computer 10 is placed in the standby mode. This is accomplished, for example, by the power controller 18 removing power from at least one component or subsystem, for example, the display controller of the laptop computer 10.

In step 105, a determination is made as to whether a new event signal, for example, a reset command or power on command has been received by the processor 12.

In step 106, if the new event (e.g. reset or power on) command has not been received, a determination is made as to whether a time-out command or signal 31 has been received from the power controller 18. If the time-out command has not been received, operation is returned to step 104; thereby, maintaining the laptop computer 10 in the standby mode.

In step 108, if the time-out signal is received, the laptop computer is powered down completely or turned off.

If a power on command is received in step 105, laptop computer operation is resumed under the control of the second or alternate executable program in step 109. This may be accomplished, for example, by the processor 12 initiating a rapid on cycle where the power controller 18 provides power to the minimal number of laptop computer components including, but not limited to, the RAM or second memory 14 and begins executing code from the second or alternate executable program. In an exemplary embodiment, upon receipt of the power on signal, the processor 12 initiates a rapid on cycle and begins executing code from the Linux operating system that was previously loaded into the fast access memory 14 in step 102.

Alternatively, the processor 12 may begin executing code from another (or different) application program (e.g. web browser) 15 upon resuming operation. As the alternate application program is loaded from the fast access (e.g. RAM) memory 14 instead of non-volatile memory 16, the time period (e.g. latency) in which the laptop computer 10 begins execution is greatly decreased. Start up times using the present invention is typically between twenty and forty times faster than standard start up methods.

If a reset signal is received in step 105, a cold (e.g. initial) power on cycle is initiated in step 110. This is accomplished, for example, by the laptop computer 10 beginning execution of the core system software code 17 and upon completion of subsystem initialization and configuration, transferring control to the first or primary operating system or corresponding first executable program.

Thus, by implementing the silent load functionality of the present invention, start up efficiency is greatly increased as the electronic device is powered up and begins executing a second or alternate operating system that was previously loaded into fast access memory upon termination of the primary operating system. Thus, the user does not have to wait several minutes for the electronic device to reload the same or alternate operating system or other suitable executable application program from slower non-volatile memory after a power down event. Additionally, the second or alternate operating system may also include power saving features that allow the electronic device to wake up periodically to perform tasks autonomously.

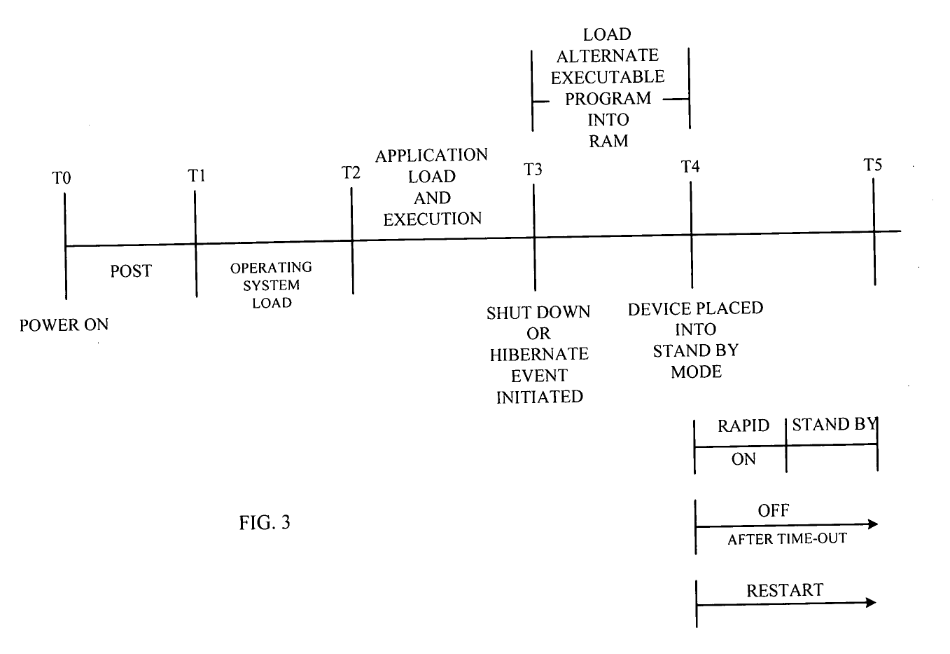

FIG. 3 is a timing diagram illustrating laptop computer 10 execution according to the present invention. At time T0, the laptop computer is turned on, for example, by a user depressing an “on”, “power” or other suitable hard key or soft key. Between T0 and T1, the core systems software performs a Power on Self Test (“POST”), whereby the underlying hardware subsystems, for example, display controller 20 and I/O controller 22 are initialized and configured and general laptop computer system checking is performed.

At time T1, the primary or first executable program, for example, the Windows™ operating system is loaded and executed. In this manner, control of the laptop computer 10 is transferred to the first operating system. The loading of the operating system and the transfer of control of the laptop computer 10 to the operating system may take upwards of three minutes as the operating system must be retrieved from the non-volatile memory 16 and transferred to the RAM or fast access memory 14.

At time T2, an application program, for example, a browser or word processing program is loaded and executed by the primary operating system. Upon completion of the requested tasks, a shut down or hibernate event is initiated at time T3. At time T4, the laptop computer 10 is placed into a stand by mode, for example, by the power controller 18 reducing or otherwise modifying power to several components of the laptop computer 10.

According to the present invention, between T3 and T4, control of the laptop computer 10 is transferred back to the core systems software 17 which then proceeds to load an alternate or second executable program, for example, the Linux operating system into the fast access RAM 14. The alternate executable program is then placed in the suspend mode using, for example, the Advanced Configuration and Power Interface (ACPI). In this manner, the alternate executable program can be rapidly turned on during a subsequent resume cycle or rapid on event. This loading of the alternate executable program during the shut down or other power management cycle is transparent to, and does not require and activity from, the user; thus, the loading of the alternate executable program is referred to as being silent.

At time T4, several operations are possible. First, a rapid on mode may be entered, for example, by the processor 12 receiving a power on or resume command. In this situation, the laptop computer 10 resumes execution from RAM or second memory 14 under the control of the second or alternate executable program. RAM 14 access takes approximately between three to six seconds to complete, as compared to several minutes for non-volatile memory access. As laptop computer 10 execution is provided by the fast access RAM 14, the latency between the user or application powering on the laptop computer or resuming operation is significantly reduced as compared to initiating execution from non-volatile memory 16. Speed enhancements of between twenty to forty percent may be accomplished.

Second, no activity is detected before the expiration of a predetermined time period. In this situation, the laptop computer 10 is turned off or completely powered down. Third, a restart mode may be entered, for example, by the processor 12 receiving a restart command from the user or an application program. In the restart mode, the laptop computer 10 is powered on and initialized through the non-volatile memory 16. Thus, standard device initialization and configuration operations are supported by the present invention. As such, electronic devices implementing the instant invention are capable of operating in a rapid on mode or conventional mode.

The foregoing detailed description of the invention has been provided for the purposes of illustration and description. Although an exemplary embodiment of the present invention has been described in detail herein with reference to the accompanying drawings, it is to be understood that the invention is not limited to the precise embodiment(s) disclosed, and that various changes and modifications to the invention are possible in light of the above teachings. Accordingly, the scope of the present invention is to be defined by the claims appended hereto.

1. A device operation method, comprising:
receiving a power down event command while executing a first executable program;
upon receipt of the power down event command, loading an alternate executable program into memory; and
entering a standby mode.

2. The method of claim 1 further including determining whether a time-out command has been received, and when the time-out command has been received, entering an off mode.

3. The method of claim 1 further including determining whether one of a power on or reset command has been received, and when a power on command has been received, resume operation from the standby mode under control of the alternate executable program.

4. The method of claim 3, wherein the alternate executable program is different from the first executable program.

5. The method of claim 1 further including determining whether one of a power on or reset command has been received, and when a reset command has been received, enter an initial power on operation.

6. The method of claim 3, further including determining whether one of a power on or reset command has been received, and when a power on command has been received, resume operation from the standby mode under control of the first executable program.

7. An electronic device, comprising:
at least one processor; and
a first memory, coupled to the at least one processor, the first memory containing instructions that when executed by the at least one processor, cause the at least one processor to:
receive a power down event command;
upon receiving the power down event command, loading an alternate executable program into a second memory; and
placing the device in a standby mode.

8. The electronic device of claim 7, wherein the first memory is a non-volatile memory.

9. The electronic device of claim 7, wherein the second memory is a volatile memory.

10. The electronic device of claim 7, wherein the executable program is one of: an operating system and an application program.

11. The electronic device of claim 10, wherein the electronic device is initially executing a first operating system and upon receiving the power down event command, loads a second operating system different from the first operating system into the second memory.

12. The electronic device of claim 7, wherein the instructions further cause the at least one processor to determine whether one of a power on or reset command has been received, and when a power on command has been received, resume operation from the standby mode under the control of the loaded alternate executable program.

13. The electronic device of claim 7, wherein the instructions further causes the at least one processor to determine whether one of a power on or reset command has been received, and when a reset command has been received, enter an initial power on operation.

14. A computer program stored in a computer readable medium for silently loading executable code, comprising:
code for receiving a power down event command;
upon receiving the power down event command, code for loading an alternate executable program into a second memory; and
code for placing an electronic device in a standby mode.

15. The computer program of claim 14, further including code that causes at least one processor to determine whether one of a power on or reset command has been received, and when a power on command has been received, resume operation from the standby mode under the control of the loaded alternate executable program.

16. The computer program of claim 14, further including code that causes at least one processor to determine whether one of a power on or reset command has been received, and when a reset command has been received, enter an initial power on operation.
